(19) United States
(12) Patent Application Publication
(10) Pub. No.: US 2015/0189004 A1
(43) Pub. Date: Jul. 2, 2015

(54) METHOD AND FARM LOAD BALANCING DEVICE FOR ESTABLISHING A BI-DIRECTIONAL SERVER TO SERVER COMMUNICATION AND COMPUTER PROGRAM THEREOF

(71) Applicant: TELEFONICA DIGITAL ESPANA, S.L.U., Madrid (ES)

(72) Inventors: Alex MASSOVER, Madrid (ES); John NEYSTADT, Kfar-Saba (IL)

(73) Assignee: TELEFONICA DIGITAL ESPANA, S.L.U., Madrid (ES)

(21) Appl. No.: 14/581,072

(22) Filed: Dec. 23, 2014

(30) Foreign Application Priority Data
Dec. 26, 2013 (ES) 13382555.4

(51) Int. Cl. H04L 29/08

(52) U.S. Cl. CPC H04L 67/1002

(57) ABSTRACT

The method comprises creating a single point in a communication flow, by a first farm load balancer, that both communication sessions requested by a client server A and a client server B at a network layer will pass through; creating stickiness based on said communication session requests and creates a bi-directional affinity by correlating the communication session requests of different sessions and maintaining a correlation mapping.

### FIELD OF THE INVENTION

The present invention is generally related within the field of network communications systems and methods. Particularly, the present invention relates to a method, a farm load balancing device and a computer program product for establishing a bi-directional affinity server to server communication.

### BACKGROUND OF THE INVENTION

In existing load balancers, there are many mechanisms to ensure affinity between a client/server and a load balanced server farm, ensuring that all requests belonging to a same session are always directed to the same server instance within the farm.

An unsolved problem in server to server communication scenarios (FIG. 1) is when a farm A consisting of multiple load balanced servers want to communicate with a farm B, also consisting of multiple load balanced servers. In this case, when each farm manages its own session (application stateful servers), a stickiness to specific server instance is required in a bi-directional way, so that all requests belonging to a session on farm A will always communicate with a specific server in farm B and all requests belonging to a corresponding session on farm B will always be routed to the same server in farm A.

Existing load balancers in the field can perform such bi-directional affinity for Layer 3 and 4 protocols (IP/UDP/TCP) as describe in U.S. Pat. No. 7,380,002, however no solution currently exists for Layer-7 protocols, such as HTTP, Radius, or others.

A common method for creating client-server affinity based on HTTP cookies is described in U.S. Pat. No. 6,473,802. Although said patent doesn't solve the problem of server to server stateful communication in case both servers perform both client and server role in client-server model. For instance, each load balancer (A_Farm_Loadbalancer or B_Farm_Loadbalancer in FIG. 1) in said patent will just implement client-server affinity method, that is, a session started from Farm A will be sticky to some server in Farm B, and corresponding session from Farm B will be also sticky to some server in Farm A, but there's no guarantee that it will be sticky to the same server, which started original session. So, the missing piece for creating bi-directional affinity in that case is the fact that no single load balancer is aware of both sessions and therefore isn't able to maintain a mapping of sessions.

### SUMMARY OF THE INVENTION

Therefore, the present invention overcomes the limitations described above by providing a method that creates a single point in the flow (load balancer) that both sessions will pass it at a network layer. Moreover, it creates stickiness based on the transaction requests and bi-directional affinity by correlating the requests of different sessions and maintaining correlation mapping.

Present invention enables to start a session on a first farm A, and correlate it to a new corresponding session in a second farm B, having load balancer to maintain a mapping between the two communication sessions (sessions are tracked using known mechanisms such as HTTP header, cookies, or URL parameters) in order to guarantee stickiness between the two communication sessions to the same server instances.

According to a first aspect there is provided a method for establishing a bi-directional server to server communication, wherein a first farm load balancer having associated a plurality of client servers comprises: a) receiving a first application level protocol request from at least one of said clients servers to start a first communication session with any of a client server associated to a second farm load balancer, said first application level protocol request including information parameters at least including a session ID that identifies the client server of the first farm load balancer; and b) sending said first application level protocol request to a client server of the second farm load balancer through the latter. Then, the client server of the second farm load balancer can respond to the first application level protocol request through said second farm load balancer.

On contrary to the known proposals the first farm load balancer further performs following steps: c) receiving a second application level protocol request from said client server of the second farm load balancer in order to start a second communication session with the client server of the first farm load balancer, said second application level protocol request including information parameters at least including a session ID that identifies the client server of the second farm load balancer and the session ID that identifies the client server of the first farm load balancer; d) checking in said received second application level protocol request if the session ID that identifies the client server of the first farm load balancer matches with the one included in the first application level protocol; and e) in case of matching, sending said second application level protocol request to the client server of the first farm load balancer, enabling the later for a response.

In accordance with an embodiment, the session ID of the client server of the first farm load balancer is included in said second application level protocol request upon extracting it, said client server of the second farm load balancer, from said received first application level protocol request.

The second application level protocol request in said step c) can be received either directly from the client server of the second farm load balancer or indirectly by using the second farm load balancer.

The response of the client server of the first farm load balancer in said step e) can be also performed directly to the client server of the second farm load balancer or indirectly through the latter.

The first and second application level protocols according to different embodiments can be the same or different protocols. Generally, those application level protocols are application-layer protocols using a client-server model. According to said different embodiments both application level protocols will be selected from at least a Hyper Text Transport Protocol (HTTP), a Remote Authentication Dial In User Service (RADIUS) protocol, a Session Initiation Protocol (SIP) protocol, or combinations thereof.

According to a second aspect there is provided a farm load balancing device for establishing a bi-directional server to server communication, said farm load balancing device having associated a plurality of client servers and being configured to: receive a first application level protocol request from at least one of said clients servers in order to start a first communication session with any of a client server associated to a second farm load balancer, said first application level protocol request including information parameters at least including a session ID that identifies its client server; and send said first application level protocol request to a client server of a second farm load balancer through the latter. The farm load balancing device also includes first means for extracting from the first application level protocol request said included session ID that identifies its client server.

On contrary of the known proposals, the farm load balancing device of the second aspect of the present invention is further configured to: receive a second application level protocol request from the client server of the second farm load balancer to start a second communication session its own client server, said second application level protocol request including information parameters at least including a session ID that identifies the client server of the second farm load balancer and the session ID that identifies its own client server; and send, depending on a checking operation, said second application level protocol request to its own client server (SA). In addition, the proposed farm load balancing device further comprises second means for performing said checking operation by checking in said received second application level protocol request if the session ID that identifies its own client server matches with the one included in the first application level protocol.

In accordance with an embodiment, the farm load balancing device is further configured to receive a response to the first application level protocol request from the client server of the second farm load balancer through the latter and to forward said response to its own client server.

Furthermore, the farm load balancing device is able similarly to receive a response to the second application level protocol request from its own client server and to forward said response to the client server of the second farm load balancer either directly or through the latter.

The system of the second aspect is adapted to implement the method of the first aspect.

The subject matter described herein can be implemented in software in combination with hardware and/or firmware, or a suitable combination of them. For example, the subject matter described herein can be implemented in software executed by a processor.

According to a third aspect there is provided a computer program product comprising a computer usable medium having a computer readable program code embodied therein, said computer readable code adapted to be executed to implement a method for establishing a bidirectional server to server communication comprising steps a to e of claim 1.

### BRIEF DESCRIPTION OF THE DRAWINGS

The previous and other advantages and features will be more fully understood from the following detailed description of embodiments, with reference to the attached, which must be considered in an illustrative and non-limiting manner, in which:

FIG. 1 illustrates a server to server communication scenario where the present invention could be implemented.

FIG. 2 is a flow chart illustrating the method of the first aspect for performing a server to server communication with bi-directional session affinity according to several embodiments, in this case particularly when the first and the second application level protocols are the same protocol, e.g. an HTTP protocol.

FIG. 3 is an example of the decision logic that a farm load balancer could execute to create affinity to a particular client server.

FIG. 4 is a flow chart illustrating the method of the first aspect for performing a bi-directional session affinity server to server communication according to several embodiments, in this case particularly when the first and the second application level protocols are different protocols, e.g. an HTTP protocol and a Radius protocol.

### DETAILED DESCRIPTION OF SEVERAL EMBODIMENTS

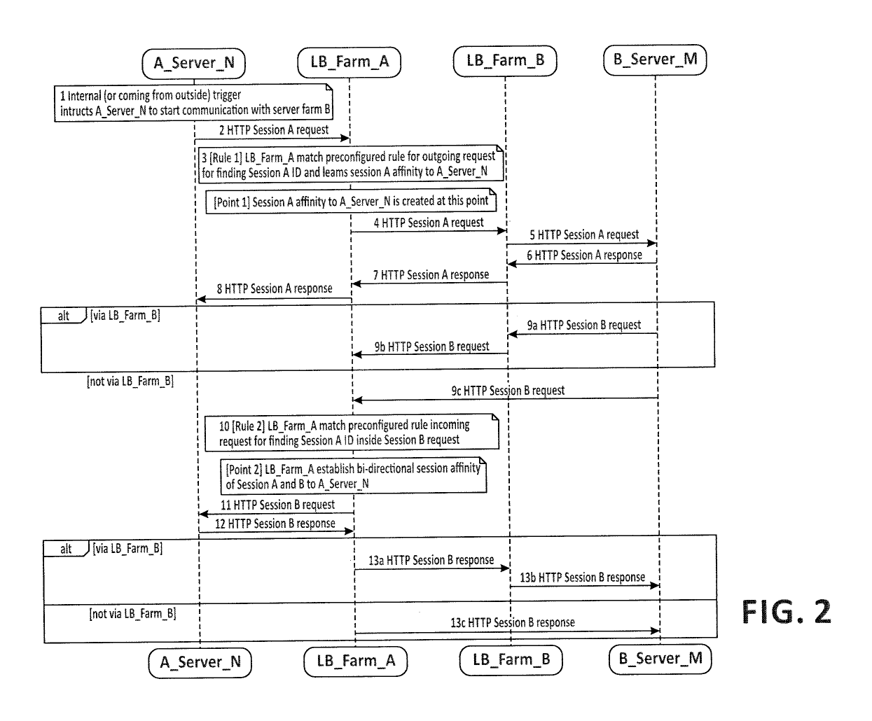

In reference to FIG. 2 it is illustrated the proposed method for establishing a bi-directional server to server communication. In this particular embodiment, the bi-directional session affinity server to server is performed over the same application level protocols, in this case an HTTP protocol.

As illustrated in FIG. 2, an external event or an internal state change instructs a particular client server A_Server_N of a first farm load balancer LB_FARM_A to start a communication session with a client server B_Server_M from a second farm load balancer LB_FARM_B (1). So, the client server A_Server_N requests the establishment of an HTTP session (Session A request as termed in FIG. 2) to the first farm load balancer LB_FARM_A by including in the HTTP session request, information parameters that identify the client server A_Server_N such as its session ID (2).

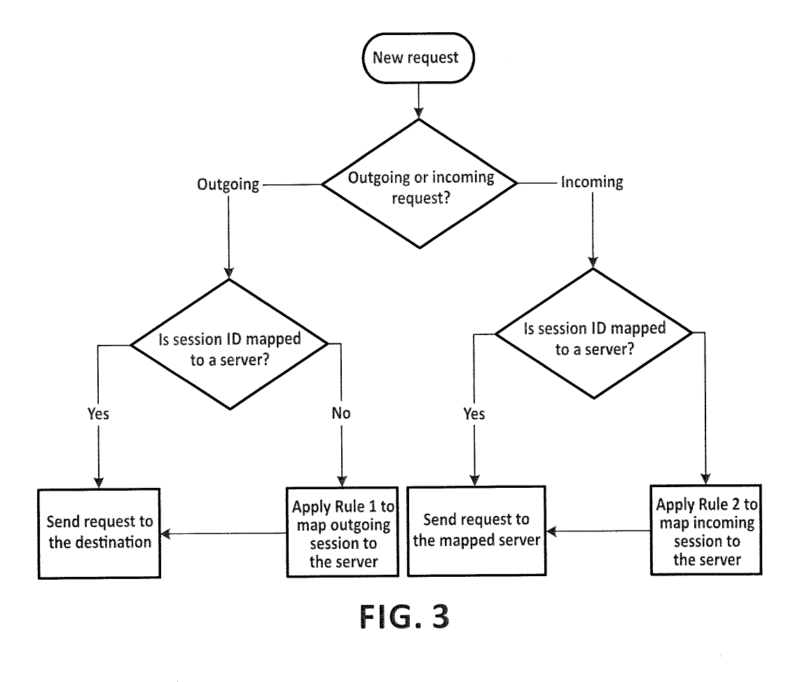

First farm load balancer LB_Farm_A upon receiving said HTTP session request executes a decision logic, as illustrated in FIG. 3, to match a preconfigured rule (Rule 1) for an outgoing request. That is, first farm load balancer LB_Farm_A finds session A ID in the received HTTP session request and learns the session affinity with said client server A_Server_N (3). Then, first farm load balancer LB_Farm_A sends the HTTP session request to said second farm load balancer LB_Farm_B (4) and the latter forwards the HTTP session request to said client server B_Server_M (5). Client server B_Server_M at that time can send a response to the HTTP session request through the second farm load balancer LB_Farm_B (6, 7 and 8).

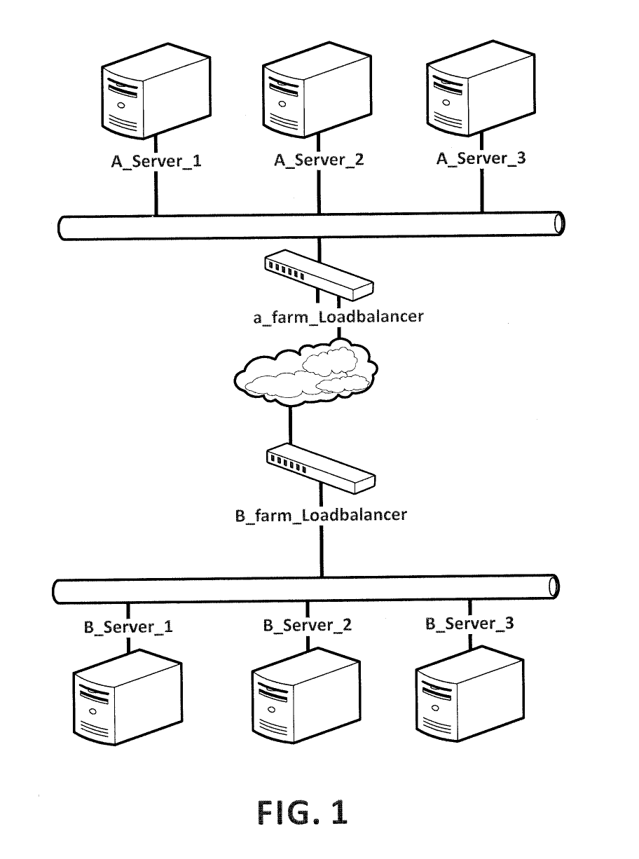

Then, client server B_Server_M sends a communication session request (HTTP Session B request as termed in FIG. 1) to the first farm load balancer LB_Farm_A either directly (9c) or alternatively via the second farm load balancer LB_Farm_B (9a and 9b). Said HTTP session B request includes at least a session ID that identifies the client server B_Server_M and the session ID that identifies the client server A_Server_N.

Therefore, the first farm load balancer LB_Farm_A upon receiving the HTTP session B request executes said decision logic illustrated in FIG. 3 to match a preconfigured rule (Rule 2) for an incoming request checking if the session ID that identifies the client server A_Server_N matches with the one included in the HTTP session A request (10). In case of matching, the first farm load balancer LB_Farm_A sends the HTTP session B request to its client server A_Server_N (11), enabling the later for a response. If client server A_Server_N (12) responds to the HTTP session B request to the first farm load balancer LB_Farm_A, the latter can forward said response either directly to the client server B_Server_M (13c) or indirectly via the second farm load balancer LB_Farm_B (13a and 13b).

The HTTP session requested by the client server A_Server_N (or HTTP Session A request) could be as follows:

POST/farm_b/form.asp HTTP/1.1

Host: farm_a

SID: ANON: farm_a: “NRviasdfmdkYB4W2471l”

That is, it includes the “SID” header, which identifies the session at the client server A_Server_N. Consequently, the HTTP session requested by the client server B_Server_M or HTTP Session B request would be as follows:

POST/farm_a/form.asp HTTP/1.1

Host: farm_b

SID: ANON: farm_b: asdfVVdfmdkYB4wsrtV

Original_ID: “NRviasdfmdkYB4W2471l”

That is, includes the “SID” header, which identifies the session at the client server B_Server_M, and the “Original_ID” header, which identifies the session at the client server A_Server_N

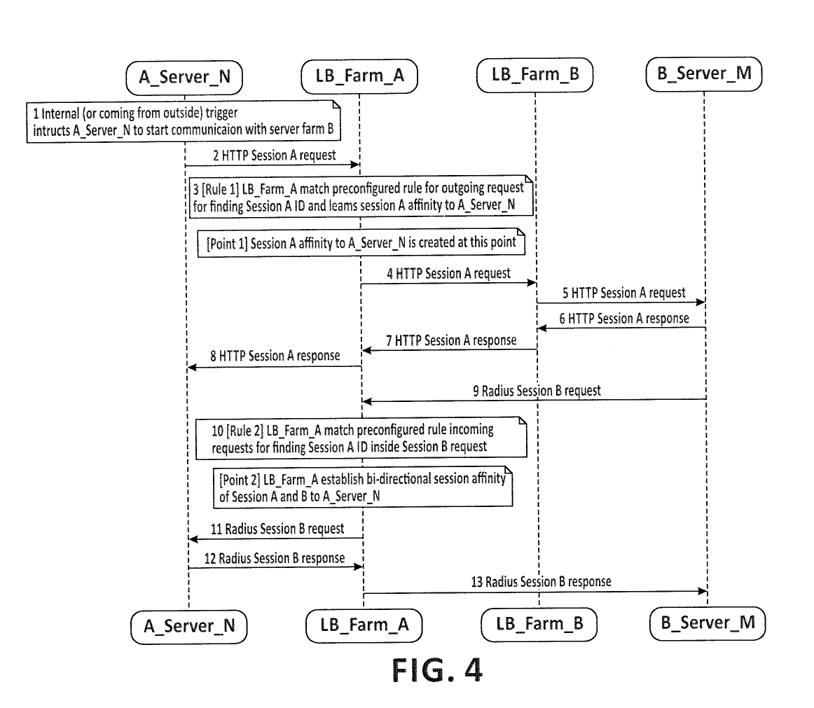

In reference to FIG. 4, it is illustrated the proposed method for establishing a bi-directional session affinity stateful server to stateful server communication over different Layer-7 protocols, which implement a client-server model such as HTTP and Radius protocols. The described flows in this case will be the same as the flows described in FIG. 2 with the only difference that the session B request demanded by the client server B_Server_M will be a Radius session request. The Radius session requested by the client server B_Server_M according to this particular embodiment could be a follows:

1 Code=Access-Request (1)

1 ID=0

2 Length=56

16 Request Authenticator

Attributes:

6 User-Name=“nemo”

18 User-Password

6 NAS-IP-Address=192.168.1.16

6 NAS-Port=3

44 Acct-Session-Id=00000016

50 Acct-Multi-Session-ld=“NRviasdfmdkY84W2471l”

That is, it includes the “Acct-Session-Id” header, which identifies the session at the client server B_Server_M, and the “Acct-Multi-Session-Id” header, which identifies the session at the client server A_Server_N

As an improvement of the invention, the first farm load balancer LB_Farm_A, once executed said rules and established the affinity of the different client servers (A_Server_N with B_Server_M) can create a mapping table storing all the linked information. For instance, in accordance to the embodiment of FIG. 2, upon having executed said rule 1, flow (3) of the figure, it could create the following mapping table:

| | | | | |
|---|---|---|---|---|
| | | Outgoing Session | Incoming Session | Affinity to |
| Rule 1 | Rule 2 | ID | ID | the server |

| | | | | | |
|---|---|---|---|---|---|
| a) | Match HTTP | c) | Match HTTP protocol | NRviasdfmdkYB4W2471I | A_Server_N |
| | protocol | d) | Match ‘Original_ID’ | | |
| b) | Match Session | | header value for matching | | |
| | Identification | | with outgoing Session ID | | |
| | URI, identifier | e) | Match Session | | |
| | field value | | Identification URI, | | |
| | | | identifier field value | | |
| | | | as Incoming Session ID | | |

And, upon having executed said rule 2, flow (10) of the figure, it could create the following mapping table:

| | | | | Outgoing Session | Incoming Session | Affinity to |
|---|---|---|---|---|---|---|
| Rule 1 | | Rule 2 | | ID | ID | the server |
| a) | Match HTTP | c) | Match HTTP protocol | NRviasdfmdkYB4W2471I | asdfVVdfmdkYB4wsrtV | A_Server_N |
| | protocol | d) | Match ‘Original_ID’ | | | |
| b) | Match Session | | header value for matching | | | |
| | Identification | | without going Session ID | | | |
| | URI, identifier | e) | Match Session | | | |
| | field value | | Identification URI, | | | |
| | | | identifier field value | | | |
| | | | as Incoming Session ID | | | |

In the same way, in accordance to the embodiment of FIG. 4, the following mapping tables could be also created:

| | | | | |
|---|---|---|---|---|
| | | Outgoing Session | Incoming Session | Affinity to |
| Rule 1 | Rule 2 | ID | ID | the server |

| | | | | | |
|---|---|---|---|---|---|
| a) | Match HTTP | c) | Match RADIUS protocol | NRviasdfmdkYB4W2471I | A_Server_N |
| | protocol | d) | Match Acct-Multi- | | |
| b) | Match Session | | Session-ID attribute | | |
| | Identification | | value for matching with | | |
| | URI, identifier | | outgoing Session ID | | |
| | field value | e) | Match Acct-Session-Id | | |
| | | | attribute value as | | |
| | | | Incoming Session ID | | |

| | | | | Outgoing Session | Incoming Session | Affinity to |
|---|---|---|---|---|---|---|
| Rule 1 | | Rule 2 | | ID | ID | the server |
| a) | Match HTTP | c) | Match RADIUS protocol | NRviasdfmdkYB4W2471I | 00000016 | A_Server_N |
| | protocol | d) | Match Acct-Multi- | | | |
| b) | Match Session | | Session-ID attribute | | | |
| | Identification | | value for matching with | | | |
| | URI, identifier | | outgoing Session ID | | | |
| | field value | e) | Match Acct-Session-Id | | | |
| | | | attribute value as | | | |
| | | | Incoming Session ID | | | |

The scope of the present invention is defined in the following set of claims.

1. Method for establishing a bi-directional server to server communication, wherein a first farm load balancer having associated a plurality of client servers performs following steps:
a) receiving a first application level protocol request from at least one of said clients servers to start a first communication session with any of a client server associated to a second farm load balancer, said first application level protocol request including information parameters at least including a session ID (ID_A) that identifies said client server; and
b) sending said first application level protocol request to a client server through said second farm load balancer,
and said client server responding to the first application level protocol request through said second farm load balancer,
characterized in that said first farm load balancer further performs following steps:
c) receiving a second application level protocol request from said server to start a second communication session with the client server, said second application level protocol request including information parameters at least including a session ID (ID_B) that identifies the client server and the session ID (ID_A) that identifies the client server;
d) checking in said received second application level protocol request if the session ID (ID_A) that identifies the client server matches with the one included in the first application level protocol; and
e) in case of matching, sending said second application level protocol request to the client server, enabling the later for a response.

2. The method of claim 1, wherein said session ID (ID_A) being included in said second application level protocol request upon having extracting it, said client server, from said received first application level protocol request.

3. The method of claim 1, wherein in said step c) the second application level protocol request is received either directly from the client server or through the second farm load balancer.

4. The method of claim 1, comprising in said step e) enabling said response either directly to the client server or through the second farm load balancer.

5. The method of claim 1, wherein said first and second application level protocol comprises a same protocol.

6. The method of claim 1, wherein said first and second application level protocol comprises different protocols.

7. The method of claim 5, wherein the first and second application level protocols are an application-layer protocol with a client-server model.

8. The method of claim 5, wherein the first and second application level protocols are selected from at least a Hyper Text Transport Protocol (HTTP), a Remote Authentication Dial In User Service (RADIUS) protocol, a Session Initiation Protocol (SIP) protocol, or combinations thereof.

9. A farm load balancing device for establishing a bi-directional server to server communication, said farm load balancing device having associated a plurality of client servers and configured to:
receive a first application level protocol request from at least one of said clients servers to start a first communication session with any of a client server associated to a second farm load balancer, said first application level protocol request including information parameters at least including a session ID (ID_A) that identifies said client server; and
send said first application level protocol request to a client server through said second farm load balancer,
and in that it comprises first means for extracting from the first application level protocol request said included session ID (ID_A) that identifies said client server,
characterized in that said farm load balancing device is further configured to:
receive a second application level protocol request from said server to start a second communication session with the client server, said second application level protocol request including information parameters at least including a session ID (ID_B) that identifies the specific client server and the session ID (ID_A) that identifies the client server; and
send, depending on a checking operation, said second application level protocol request to the client server,
and in that it further comprises second means for performing said checking operation by checking in said received second application level protocol request if the session ID (ID_A) that identifies the client server matches with the one included in the first application level protocol.

10. The farm load balancing device of claim 9, wherein is further configured to receive a response to the first application level protocol request from the client server through said second farm load balancer and to forward said response to the client server.

11. The farm load balancing device of claim 9 wherein is further configured to receive a response to the second application level protocol request from the client server and to forward said response to the client server either directly or through the second farm load balancer.

12. A computer program product comprising a computer usable medium having a computer readable program code embodied therein, said computer readable code adapted to be executed to implement a method for establishing a bidirectional server to server communication comprising steps a to e of claim 1.
